(19) United States
(12) Patent Application Publication
(10) Pub. No.: US 2006/0182493 A1
(43) Pub. Date: Aug. 17, 2006

(54) Apparatus for magnetically coupling a position instrument

(76) Inventor: George I. Skoda, Santa Clara, CA (US)

Correspondence Address: HARNESS, DICKEY & PIERCE, P.L.C., P.O. BOX 8910, RESTON, VA, 20195, US

(21) Appl. No.: 11/056,122

(22) Filed: Feb. 14, 2005

(51) Int. Cl. F16B 5/00

(52) U.S. Cl. 403/335

(57) ABSTRACT

An apparatus for coupling a position instrument includes a first disk including a collar, and a second disk including a collar positioned substantially inverse relation to the first disk. A plurality of magnets may be embedded in the first and second disks.

### BACKGROUND OF INVENTION

1. Field of the Invention

This invention relates generally to an apparatus for magnetically coupling a position instrument.

2. Description of Related Art

Generally, a position instrument, such as, for example a rotary variable differential transformer (RVDT) is a known transducer device used for measuring angular displacement. Mechanical angular displacement and/or rotation is converted into analog electrical signals suitable for processing, control and display. An RVDT may typically be mechanically connected to a shaft feedback rod to determine angular displacement of a sensing element. A flexible coupler may be positioned between the RVDT and the feedback rod. The coupler may be used to attach the. RVDT and the shaft feedback rod instruments via collars with a setscrew in each collar. However, in some instances, vibrations of the shaft feedback rod may cause the flexible coupler to fail due to fatigue. Vibrations may further loosen the setscrews in the collars so as to cause the coupler to fail.

### SUMMARY OF THE INVENTION

Exemplary embodiments of the present invention may provide a coupling apparatus for a position instrument. The coupling apparatus may include a first disk including a collar, and a second disk including a collar positioned substantially inversely to the first disk, and a plurality of magnets embedded on the first and second disks.

In other exemplary embodiments, the first and second disks may be made of non-magnetic material.

In other exemplary embodiments, the non-magnetic material may be at least one of an aluminum and a stainless steel.

In other exemplary embodiments, each of the collar of the first and second disks may include a setscrew for fastening the disk to at least one of a feedback rod and a position instrument.

In yet other exemplary embodiments, the collar of the first disk may be connected to the position instrument, and the collar of the second disk may be connected to the feedback rod.

In yet other exemplary embodiments, the position instrument may be a radial variable differential transformer.

In other exemplary embodiments, the first disk may further comprises a metal shield to reduce the instrument from stray magnetic fields.

In yet other exemplary embodiments, the metal shield may be made of Mu metal for magnetic shielding.

In other exemplary embodiments, the first and second disks may not be connected and provided with a gap.

In yet other exemplary embodiments, the gap may be approximately 0.040 inches.

In other exemplary embodiments, the plurality of magnets may be embedded with at least three magnets.

In yet other exemplary embodiments, the plurality of magnets may be provided with indents.

Exemplary embodiments of the present invention may be directed to a reliable, non-connecting coupling apparatus for a position instrument to reduce and/or eliminate fatigue failures for mechanical couplings or an instrument.

### BRIEF DESCRIPTION OF THE DRAWINGS

The present invention will become more apparent by describing, in detail, exemplary embodiments thereof with reference to the attached drawings, wherein like procedures are represented by like reference numerals, which are given by way of illustration only and thus do not limit the exemplary embodiments of the present invention.

FIG. 1 is a sectional view of a coupling apparatus in accordance with an exemplary embodiment of the present invention.

FIG. 2A is a cross-sectional view A-A of a disk in accordance with an exemplary embodiment of the present invention.

FIG. 2B is a cross-sectional view B-B of a magnet in accordance with an exemplary embodiment of the present invention.

### DETAILED DESCRIPTION OF EXEMPLARY EMBODIMENTS

It should be noted that these Figures are intended to illustrate the general characteristics of method and apparatus of exemplary embodiments of this invention, for the purpose of the description of such exemplary embodiments herein. These drawings are not, however, to scale and may not precisely reflect the characteristics of any given embodiment, and should not be interpreted as defining or limiting the range of values or properties of exemplary embodiments within the scope of this invention. The relative dimensions and size of the coupling apparatus may be reduced or exaggerated for clarity. Like numerals are used for liked and corresponding parts of the various drawings.

Exemplary embodiments of the present invention may provide a reliable non-connecting coupling apparatus for a position instrument, such as a RVDT to reduce and/or eliminate fatigue failures of connecting couplings or instrument.

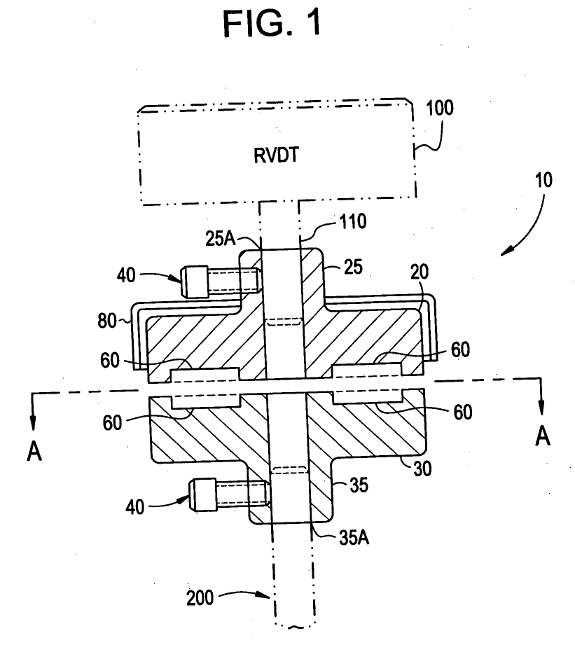

FIG. 1 is a sectional view of a coupling apparatus in accordance with an exemplary embodiment of the present invention. Referring to FIG. 1, a coupling apparatus 10 may be connected between a shaft position instrument, such as, for example a rotary variable differential transformer (RVDT) 100 via a rod 110 and a feedback rod 200 of the shaft. The coupling apparatus 10 may include a first disk 20 and a second disk 30. The second disk 30 may have substantially the same identical shape as the first disk 20 except that the second disk 30 is inversely positioned. The disks 20, 30 may be generally circular in shape. However, it should be appreciated that other shapes may be employed. The disks 20, 30 may be made from non-magnetic materials, such as, but not limited to, aluminum or stainless steel.

Corresponding collars 25, 35 may be positioned about the center of the disks 20, 30 extending away from the center of the disks 20, 30. Each collar 25, 35 includes a corresponding bore 25a, 35a for slideable engagement between the instrument rod 110 and feedback rod 200. Setscrews 40 may be used to firmly attach the disks 20, 30 to the position instrument rod 110 and the feedback rod 200. It should be appreciated that other types of fasteners may be employed to attach the collars to the rods.

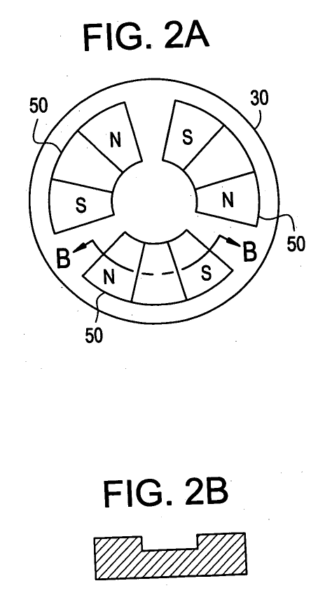

The disks 20, 30 may be provided with a plurality of magnets 50 (shown in FIG. 2A) embedded in slots 60. The magnets 50 produce a magnetic field in the disks 20, 30 so as to provide a gap or channel between the disks 20, 30. As an example, the gap may be 0.040 inches, although the gap may have different dimensions.

A metal shield 80 may be provided on the first disk 20 closest to the position instrument 100 to shield the instrument from stray magnetic fields. Stray magnetic fields affect the accurate reading of the position instrument 100. The metal shield may be made of Mu metal, for example. The Mu metal may be an alloy comprised of about 77% nickel, 15% iron, plus copper and molybdenum. However, it should be appreciated that the metal shield may be made from other materials so long as it shields the stray magnetic fields.

FIG. 2A is a cross-sectional view A-A of taken from FIG. 1 in accordance with an exemplary embodiment of the present invention. As discussed above, a plurality of magnets 50 may be embedded in slots 60. Each magnet 50 may be a substantially semi-circular to engage the shape of the slots 60. Each magnet 50 may be positioned with opposite poles with respect to each other. In other words, one magnet has a north pole and a south pole, and the next adjacent magnet can be positioned with the opposite pole to generate a greater magnetational force between the adjacent magnets 50. Moreover, the corresponding magnets 50 in the other half of the disk 20 or 30 can be positioned in such a manner that the north poles of magnets 50 in disk 20 can be positioned as opposite south poles in disk 30, for example. In this manner, the opposing poles may attract each other and form the basis for coupling. As an exemplary embodiment three magnets are shown in FIG. 2A, however, greater or fewer than three magnets may be employed to generate the desired magnetic force. It should be appreciated that the magnets 50 may be made of magnetic metals, for example, but not limited to, iron, nickel, cobalt, alloys (mixtures), and any combination thereof

FIG. 2B is a cross-sectional view B-B of a magnet 50 in accordance with an exemplary embodiment of the present invention. As shown in FIG. 2B, magnets 50 may include indents at substantially the central portion of the magnet. The indents on the magnets are to form essentially a small horseshoe-like shape of the magnet.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

What is claimed:

1. A coupling apparatus for a position instrument, comprising:
a first disk including a collar;
a second disk including a collar, the second disk positioned substantially in an inverse relationship to the first disk; and
a plurality of magnets embedded in the first and second disks.

2. The coupling apparatus of claim 1, wherein the first and second disks are made of a non-magnetic material.

3. The coupling apparatus of claim 2, wherein the non-magnetic material is at least one of aluminum and stainless steel.

4. The coupling apparatus of claim 1, wherein each of the collars of the first and second disks include a setscrew for fastening the disks to at least one of a feedback rod and the position instrument.

5. The coupling apparatus of claim 4, wherein the collar of the first disk is connected to the position instrument, and the collar of the second disk is connected to the feedback rod.

6. The coupling apparatus of claim 5, wherein the position instrument is embodied as a radial variable differential transformer.

7. The coupling apparatus of claim 1, wherein the first disk further includes a metal shield.

8. The coupling apparatus of claim 7, wherein the metal shield is made of Mu metal.

9. The coupling apparatus of claim 1, wherein the first and second disks are not connected to each other, and have a gap therebetween.

10. The coupling apparatus of claim 9, wherein the gap is approximately 0.040 inches.

11. The coupling apparatus of claim 1, wherein the plurality of magnets include at least three magnets.

12. The coupling apparatus of claim 11, wherein one or more of the plurality of magnets include an indented portion.
